(19) United States
(12) Patent Application Publication
(10) Pub. No.: US 2020/0295348 A1
(43) Pub. Date: Sep. 17, 2020

(54) NEGATIVE ELECTRODE FOR NON-AQUEOUS ELECTROLYTE SECONDARY BATTERY AND NON-AQUEOUS ELECTROLYTE SECONDARY BATTERY USING THE SAME

(71) Applicant: TDK CORPORATION, Tokyo (JP)

(72) Inventors: Yuusuke YAMAGUCHI, Tokyo (JP); Tohru INOUE, Tokyo (JP); Yasuhiro TAKAGI, Tokyo (JP)

(73) Assignee: TDK CORPORATION, Tokyo (JP)

(21) Appl. No.: 16/810,392

(22) Filed: Mar. 5, 2020

(30) Foreign Application Priority Data
Mar. 15, 2019 (JP) 2019-047944

(51) Int. Cl. H01M 4/131; H01M 4/525; H01M 4/505; H01M 10/0585; H01M 10/0525

(52) U.S. Cl. CPC H01M 4/131; H01M 4/525; H01M 2004/027; H01M 10/0585; H01M 10/0525; H01M 4/505

(57) ABSTRACT

Disclosed herein is a negative electrode for non-aqueous electrolyte secondary battery that includes a negative electrode current collector, and a negative electrode active material layer. An area change rate and a thickness change rate of the negative electrode active material layer associated with charging are 0.1% or more and 10% or more, respectively. A triangular region having an intersection between first and second straight lines, a first point existing on the first straight line and being away from the intersection in the first direction toward the first side by a first distance, and a second point exists on the second straight line and being away from the intersection in the second direction toward the second side by a second distance, as vertices are cut away such that the triangular region has neither the negative electrode current collector nor the negative electrode active material layer.

### BACKGROUND OF THE INVENTION

### Field of the Invention

The present invention relates to a negative electrode for non-aqueous electrolyte secondary battery and a non-aqueous electrolyte secondary battery using the same and, more particularly, to a high capacity negative electrode for non-aqueous electrolyte secondary battery having a negative electrode active material layer whose area change rate associated with charging is 0.1% or more and thickness change rate associated with charging is 10% or more and a non-aqueous electrolyte secondary battery using such a negative electrode.

### Description of Related Art

A lithium secondary battery has recently been put into practical use as a secondary battery exhibiting a high output and a high weight energy density. The lithium secondary battery is more excellent in weight energy density, cycle characteristics, output-input characteristics, storage characteristics than conventional secondary batteries, so that it is becoming widely prevalent in the fields of mobile devices, on-vehicle batteries, household heavy appliances, and the like.

As described in Japanese Patent No. 5,319,613, in a general lithium secondary battery, graphite is used as a negative electrode active material. The theoretical capacity of graphite is 372 mAh/g. In recent years, in order to achieve a higher weight energy density than the general lithium secondary battery using graphite as a negative electrode active material, a lithium secondary battery of a type using, as a negative electrode active material, inorganic particles composed of silicon (Si), or silicon oxide (SiOx) having a significantly higher theoretical capacity than graphite and a lithium secondary battery of a type using metal as a negative electrode are currently under development (see JP 2013-191578 A).

However, the inorganic particles composed of silicon (Si) or silicon oxide (SiOx) are accompanied by a large volumetric expansion during charging, so that the area change rate and thickness change rate of the negative electrode active material layer associated with charging reach up to 0.1% or more and 10% or more, respectively. Thus, when charging/discharging is repeatedly performed, there may occur deformation such as wrinkling or cracking due to a strong stress, leading to a reduction in the lifetime, reliability, and safety of the battery.

### SUMMARY

It is therefore an object of the present invention to suppress deformation that may occur through repetition of charging/discharging in a high capacity negative electrode for non-aqueous electrolyte secondary battery whose area change rate and thickness change rate associated with charging are 0.1% or more and 10% or more, respectively. Another object of the present invention is to provide a non-aqueous electrolyte secondary battery using such a negative electrode for non-aqueous electrolyte secondary battery.

A negative electrode for non-aqueous electrolyte secondary battery according to the present invention includes a negative electrode current collector, and a negative electrode active material layer including a negative electrode active material disposed on a surface of the negative electrode current collector. An area change rate and a thickness change rate of the negative electrode active material layer associated with charging are 0.1% or more and 10% or more, respectively. Each of the negative electrode current collector and the negative electrode active material layer has a first side extending in a first direction and a second side extending in a second direction perpendicular to the first direction. A triangular region having an intersection, a first point, and a second point as vertices are cut away such that the triangular region has neither the negative electrode current collector nor the negative electrode active material layer, where the intersection is defined between a first straight line along the first side and a second straight line along the second side, where the first point exists on the first straight line and being away from the intersection in the first direction toward the first side by a first distance, and where a second point exists on the second straight line and being away from the intersection in the second direction toward the second side by a second distance.

According to the present invention, a stress concentration point is positioned outside the negative electrode, so that it is possible to suppress deformation generated due to repetition of charging/discharging in a high capacity negative electrode for non-aqueous electrolyte secondary battery having a negative electrode active material whose area change rate is 0.1% or more and thickness change rate is 10% or more. The thickness change rate refers to a ratio of the initial negative electrode thickness (thickness after at least one cycle of charging/discharging) to the negative electrode thickness after 100 or more cycles of charging/discharging.

A non-aqueous electrolyte secondary battery according to the present invention includes: a positive electrode having a positive electrode current collector and a positive electrode active material layer including a positive electrode active material disposed on the surface of the positive electrode current collector; and a separator disposed between the positive and negative electrodes. According to the present invention, there can be provided a non-aqueous electrolyte secondary battery using the negative electrode that is less likely to be deformed even after repetition of charging/discharging despite its high capacity.

In the present invention, the positive electrode active material may contain lithium nickel composite oxide represented by a general formula: LiₐNi_{b}Mn_{c}Co_{d}MₓO₂ (where a, b, c, d, and x satisfy 0.9≤a≤1.2, 0<b<1, 0<c≤0.5, 0<d≤0.5, 0≤x≤0.3, b+c+d=1, and M is at least one element selected from a group consisting of Ti, Zr, Nb, W, P, Al, Mg, V, Ca, Sr, and Cr). Such a positive active material has a high capacity, so that the amount of lithium absorbed into the negative electrode is large during charging. As a result, the negative electrode is changed in area and volume more significantly in association with charging/discharging; even in this case, deformation of the negative electrode can be suppressed.

In the present invention, the separator may have a structure obtained by laminating a heat-resistant insulating layer on a porous body. Thus, even when the separator has become high temperature, the positive and negative electrodes can be reliably electrically insulated from each other.

In the present invention, the negative electrode may have a capacity per unit area of 1.2 mAh/cm² or more. Such a high capacity negative electrode is significantly changed in area and volume in association with charging/discharging; even in this case, deformation of the negative electrode can be suppressed.

The non-aqueous electrolyte secondary battery according to the present invention may be a stacked type battery in which the positive electrode, negative electrode, and separator are encapsulated in an outer casing made of a laminate film or a metal can. In the stacked type battery, an electrode layer has a planar structure, so that deformation is likely to occur by a stress generated in the electrode layer. Thus, it is particularly effective to apply the present invention to the stacked type battery.

As described above, according to the present invention, it is possible to suppress deformation that may occur through repetition of charging/discharging in a high capacity negative electrode for non-aqueous electrolyte secondary battery whose area change rate and thickness change rate associated with charging are 0.1% or more and 10% or more, respectively. Further, according to the present invention, there can be provided a non-aqueous electrolyte secondary battery using such a negative electrode for non-aqueous electrolyte secondary battery.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a schematic cross-sectional view of a non-aqueous electrolyte secondary battery according to a preferred embodiment of the present invention;

FIG. 2 is a plan view of the negative electrode having a typical shape;

FIG. 3 is a plan view of the negative electrode having a typical shape in a state where crack occurs;

FIG. 4 is a plan view for explaining a definition of a triangular region;

FIG. 5 is a plan view illustrating a first example of the negative electrode;

FIG. 6 is a plan view illustrating a second example of the negative electrode;

FIG. 7 is a plan view illustrating a third example of the negative electrode; and

FIG. 8 is a plan view illustrating a fourth example of the negative electrode.

### DETAILED DESCRIPTION OF THE EMBODIMENTS

Preferred embodiments of the present invention will be explained below in detail with reference to the accompanying drawings.

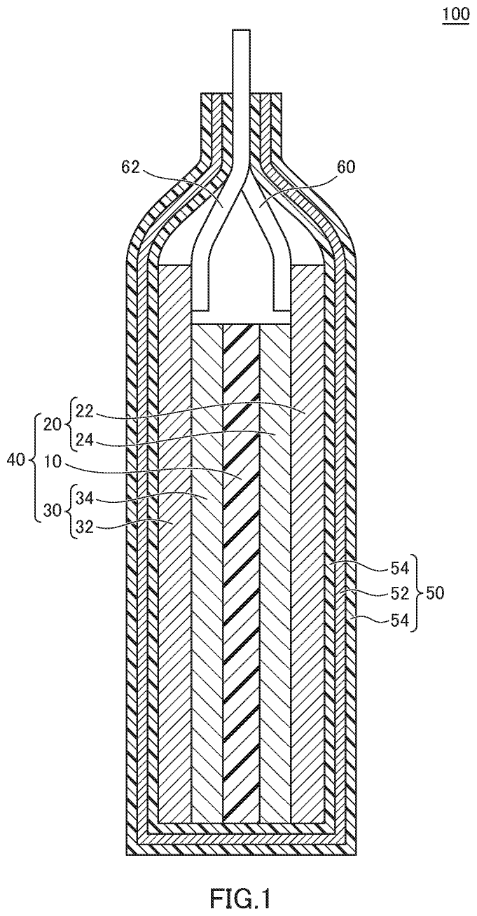

FIG. 1 is a schematic cross-sectional view of a non-aqueous electrolyte secondary battery 100 according to a preferred embodiment of the present invention.

The non-aqueous electrolyte secondary battery 100 according to the present embodiment is a lithium secondary battery and includes, as illustrated in FIG. 1, a laminated body 40, a casing 50 that hermetically houses therein the laminated body 40, and a pair of leads 60 and 62 connected to the laminated body 40. Although not illustrated, a non-aqueous electrolyte solution is encapsulated in the casing 50 together with the laminated body 40.

The laminated body 40 includes a positive electrode 20, a negative electrode 30, and a separator 10 disposed between the positive and negative electrodes 20 and 30. The positive electrode 20 is obtained by forming a positive electrode active material layer 24 on the surface of a plate-like (film-like) positive electrode current collector 22. The negative electrode 30 is obtained by forming a negative electrode active material layer 34 on the surface of a plate-like (film-like) negative electrode current collector 32. The positive electrode active material layer 24 and negative electrode active material layer 34 contact both surfaces of the separator 10, respectively. The positive electrode current collector 22 and the negative electrode current collector 32 are connected respectively with the leads 60 and 62 at their end portions. The end portions of the leads 60 and 62 extend to the outside of the casing 50. Although only one laminated body 40 is housed in the casing 50 in the example illustrated in FIG. 1, a plurality of the laminated bodies 40 may be housed in the casing 50.

Hereinafter, components constituting the non-aqueous electrolyte secondary battery 100 will be described.

### (Positive Electrode Current Collector)

The positive electrode current collector 22 may be a conductive plate material. For example, a metal foil or a metal thin plate made of aluminum, copper, or nickel may be used.

### (Positive Electrode Active Material Layer)

The positive electrode active material layer 24 includes a positive electrode active material, a positive electrode conductive auxiliary agent, and a positive electrode binder. The component ratio of the positive electrode active material in the positive electrode active material layer 24 is preferably 80% or more and 90% or less in a mass ratio. Further, the component ratio of the positive electrode conductive auxiliary agent in the positive electrode active material layer 24 is preferably 0.5% or more and 10% or less in a mass ratio, and the component ratio of the positive electrode binder in the positive electrode active material layer 24 is preferably 0.5% or more and 10% or less in a mass ratio.

### (Positive Electrode Active Material)

The positive electrode active material used in the positive electrode active material layer 24 may be an electrode active material capable of reversibly progressing lithium ion absorption and release, lithium ion desorption and intercalation, or doping and dedoping between lithium ion and a counter anion (e.g., PF₆⁻) of lithium ion.

Examples of the positive electrode active material include lithium cobalt oxide (LiCoO₂), lithium nickel oxide (LiNiO₂), lithium-manganese spinel (LiMn₂O₄), and lithium nickel composite oxide represented by a general formula: LiₐNi_{b}Mn_{c}Co_{d}MₓO₂ (where a, b, c, d, and x satisfy 0.9≤a≤1.2, 0<b<1, 0<c≤0.5, 0<d≤0.5, 0≤x≤0.3, b+c+d=1, and M is at least one element selected from a group consisting of Ti, Zr, Nb, W, P, Al, Mg, V, Ca, Sr, and Cr), lithium vanadium compound (LiV₂O₅), and compound metal oxides such as olivine-type LiMPO₄ (where M is at least one element selected from a group consisting of Co, Ni, Mn, Fe, Mg, Nb, Ti, Al, and Zr, or VO), lithium titanate (Li₄Ti₅O₁₂), and LiNiₓCo_{y}Al_{z}O₂ (0.9<x+y+z<1.1).

Concrete examples of the positive electrode active material include lithium nickel-cobalt-aluminate (NCA), lithium cobalt oxide (LCO), and lithium nickel-cobalt-manganese oxide (NCM).

### (Positive Electrode Conductive Auxiliary Agent)

Examples of the positive electrode conductive auxiliary agent contained in the positive electrode active material layer 24 include carbon powder such as carbon blacks, fine metal powder such as carbon nanotube, carbon materials, copper, nickel, stainless steel, and iron, a mixture of carbon materials and fine metal powder, and conductive oxide such as ITO. When sufficient conductivity can be achieved with only the positive electrode active material, the positive electrode active material layer 24 need not contain the positive electrode conductive auxiliary agent.

### (Positive Electrode Binder)

The positive electrode binder contained in the positive electrode active material layer 24 plays a role of binding the positive electrode active materials and binding the positive electrode active material and the positive electrode current collector 22. The positive electrode binder may be any material capable of achieving the above bonding, and examples thereof include fluororesins such as polyvinylidene fluoride (PVDF), polyethersulfone (PESU), polytetrafluoroethylene (PTFE), tetrafluoroethylene-hexafluoropropylene copolymer (FEP), tetrafluoroethylene-perfluoroalkylvinylether copolymer (PFA), ethylene-tetrafluoroethylene copolymer (ETFE), polychlorotrifluoroethylene (PCTFE), ethylene-chlorotrifluoroethylene copolymer (ECTFE), and polyvinylfluoride (PVF).

In addition to those described above, vinylidene fluoride fluorine rubber may be used as the positive electrode binder, and concrete examples thereof include: vinylidene fluoride-hexafluoropropylene fluorine rubber (VDF-HFP fluorine rubber), vinylidene fluoride-hexafluoropropylene-tetrafluoroethylene fluorine rubber (VDF-HFPTFE fluorine rubber), vinylidene fluoride-pentafluoropropylene fluorine rubber (VDF-PFP fluorine rubber), vinylidene fluoride-pentafluoropropylene-tetrafluoroethylene fluorine rubber (VDF-PFP-TFE fluorine rubber), vinylidene fluoride-perfluoromethylvinylether-tetrafluoroethylene fluorine rubber (VDF-PFMVE-TFE fluorine rubber), and vinylidene fluoride-chlorotrifluoroethylene fluorine rubber (VDF-CTFE fluorine rubber).

The positive electrode binder may be formed of conductive polymer with electronic conductivity and conductive polymer with ionic conductivity. An example of the conductive polymer with electronic conductivity is polyacetylene. In this case, the positive electrode binder exhibits the function of a conductive auxiliary agent and, therefore, a positive electrode conductive auxiliary agent need not be added. An example of the conductive polymer with ionic conductivity is obtained by combining alkali metal salt, which contains lithium salt or lithium mainly, with a polymer compound such as polyethylene oxide and polypropylene oxide.

### (Negative Electrode Current Collector)

The negative electrode current collector 32 may be made of a conductive plate material. For example, a metal foil or a metal thin plate made of aluminum, copper, or nickel may be used.

### (Negative Electrode Active Material)

The negative electrode active material layer 34 includes a negative electrode active material, a negative electrode conductive auxiliary agent, and a negative electrode binder.

### (Negative Electrode Active Material)

The negative electrode active material is composed of particles containing at least silicon (Si), tin (Sn), or oxide thereof. However, inorganic particles other than the above may be contained. Such a negative electrode active material is higher in capacity than graphite and can have a capacity per unit area of 1.2 mAh/cm² or more and a rated capacity of 3 Ah or more. However, the inorganic particles composed of silicon (Si), tin (Sn), or oxide thereof is accompanied by a large volumetric expansion during charging, so that the area change rate and thickness change rate of the negative electrode active material layer associated with charging reach up to 0.1% or more and 10% or more, respectively.

### (Negative Electrode Conductive Auxiliary Agent)

As the negative electrode conductive auxiliary agent used in the negative electrode active material layer 34, the same material as that for the positive electrode conductive auxiliary agent used in the positive electrode active material layer 24 can be used. That is, carbon powder such as carbon blacks, fine metal powder such as carbon nanotube, carbon materials, copper, nickel, stainless steel, and iron, a mixture of carbon materials and fine metal powder, and conductive oxide such as ITO can be used.

### (Negative Electrode Binder)

As negative electrode binder used in the negative electrode active material layer 34, the same material as for the positive electrode binder used in the positive electrode active material layer 24 can be used. Other examples of the negative electrode binder include, e.g., cellulose, styrene butadiene rubber, ethylene propylene rubber, polyimide resin, polyamide imide resin, and acrylic resin.

### (Non-Aqueous Electrolyte Solution)

The non-aqueous electrolyte solution may be an electrolyte (aqueous electrolyte solution or electrolyte solution using an organic solvent) containing lithium salt. However, the aqueous electrolytic solution has an electrochemically low decomposition voltage, which limits the tolerable voltage during charging, so that the electrolyte solution (non-aqueous electrolyte solution) using an organic solvent is preferably used. As the electrolyte, a solution obtained by dissolving lithium salt in non-aqueous solvent (organic solvent) is suitably used. The lithium salt is not particularly limited, and any lithium salt that can be used as an electrolyte for a lithium ion secondary battery may be used. Examples of the lithium salt include an inorganic acid anionic salt such as LiPF₆, LiBF₄, LiClO₄, LiFSI, or LiBOB, and an organic acid anionic salt such as LiCF₃SO₃, LiTFSI, or LiBETI.

Examples of the organic solvent include an aprotic high-dielectric-constant solvent such as ethylene carbonate, propylene carbonate, or fluoroethylene carbonate and an aprotic low-viscosity solvent such as acetates, such as dimethyl carbonate or ethylmethyl carbonate, or propionates. The aprotic high-dielectric-constant solvent and aprotic low-viscosity solvent are desirably used together at an adequate mixing ratio.

The non-aqueous electrolyte solution may contain an ionic liquid. The ionic liquid is a salt obtained by combinations of cations and anions and is liquid even at a temperature of less than 100° C. The ionic liquid is a liquid composed only of ions, so that it is characterized by strong electrostatic interaction, non-volatility, and non-flammability. A lithium secondary battery using the ionic liquid as the electrolyte solution is excellent in safety. Various types of ionic liquids are obtained by combinations of the cations and the anions. Examples of the ionic liquid include a nitrogen-based ionic liquid such as an imidazolium salt, a pyrrolidinium salt, a piperidinium salt, a pyridinium salt, or an ammonium salt, a phosphorus-based ionic liquid such as a phosphonium salt, and a sulfur-based ionic liquid such as a sulfonium salt. The nitrogen-based ionic liquid can be classified into ring ammonia salts and chain ammonia salts. Examples of the lithium salt include an inorganic acid anionic salt such as LiPF₆, LiBF₄, or LiBOB and an organic acid anionic salt such as LiTFSA (LiN (CF₃SO₂)₂), LiFSA (LiN (FSO₂)₂), LiCF₃SO₃, (CF₃SO₂)₂NLi, or (FSO₂)₂NLi.

The concentration of the lithium salt contained in the electrolyte solution is preferably 0.5 M to 2.0 M in terms of electric conductivity. The conductivity of the electrolyte at a temperature of 25° C. is preferably 0.01 S/m or more and is controlled depending on the type of an electrolyte salt or concentration of the electrolyte salt.

### (Separator)

The separator 10 is formed of a porous structure with an electrically insulating property. Examples of the separator 10 include a single or multilayer film made of polyethylene, polypropylene, or polyolefin, extended films of mixtures of the resins mentioned above; and fibrous nonwoven fabrics made of at least one kind of constituent material selected from a group consisting of cellulose, polyester, and polypropylene. The separator 10 may be formed by laminating a heat-resistant insulating layer on a porous body.

### (Casing)

The casing 50 houses therein the laminated body 40 and non-aqueous electrolyte solution in a hermetical manner. The type of the casing 50 is not particularly limited as long as it can prevent the non-aqueous electrolyte solution from leaking outside and prevent moisture and the like from entering the inside of the non-aqueous electrolyte secondary battery 100.

For example, as illustrated in FIG. 1, a metal laminate film obtained by coating a metal foil 52 from both sides with two polymer films 54 can be used as the outer casing 50. In this case, an aluminum foil can be used as the metal foil 52, and a polypropylene film can be used as the polymer film 54. As the material for the outer polymer film 54, a polymer having a high melting point, such as polyethylene terephthalate (PET) or polyamide is preferably used, and as the material for the inner polymer film 54, polyethylene (PE) or polypropylene (PP) is preferably used.

### (Lead)

The leads 60 and 62 are each formed from a conductive material such as a metal plate plated with aluminum, nickel, or copper. In particular, the lead 60 connected to the positive electrode 20 is preferably formed of an aluminum metal plate, and the lead 62 connected to the negative electrode 30 is preferably formed of a nickel metal plate or a metal plate obtained by plating copper with nickel.

The following describes a stress applied to the negative electrode 30 associated with charging/discharging.

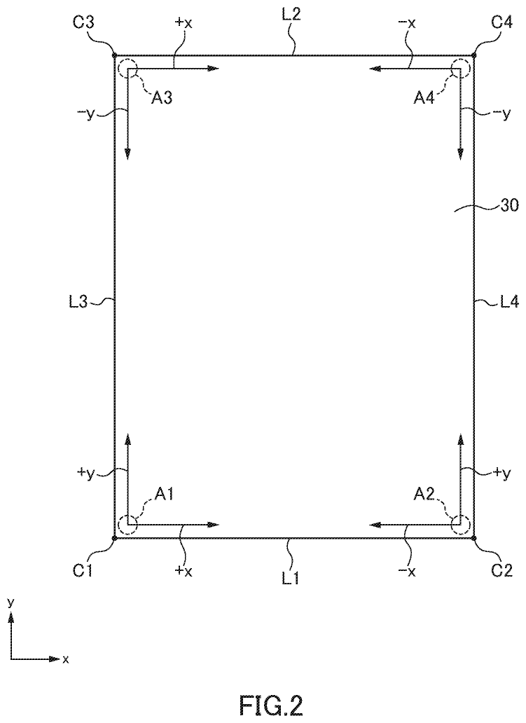

FIG. 2 is a plan view of the negative electrode 30 having a typical shape. As illustrated in FIG. 2, the negative electrode 30 having a typical shape has a substantially rectangular shape in a plan view (as viewed in the lamination direction). Thus, the negative electrode 30 has two sides L1 and L2 extending in the x-direction and two sides L3 and L4 extending in the y-direction, and two sides terminate at a corner (C1 to C4). When charging/discharging are repeatedly performed in the thus shaped negative electrode 30, a strong stress is generated in both the planar and lamination directions. In particular, when the area change rate and thickness change rate of the negative electrode active material layer 34 associated with charging reach up to 0.1% or more and 10% or more, respectively, a stress concentration point occurs around the corners of the rectangular negative electrode 30.

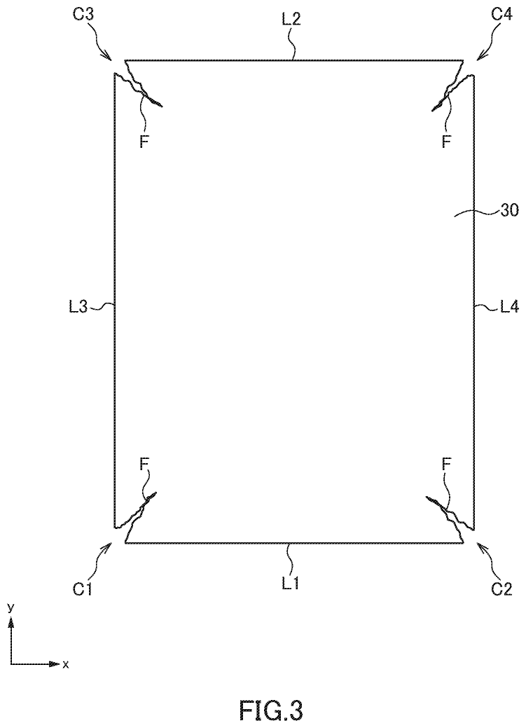

For example, discharging is started from the negative electrode 30 that has expanded due to charging, the negative electrode 30 contracts. At this time, a stress concentrates on regions A1 to A4 around the respective corners. For example, in the sides L1 and L2 extending in the x-direction, a stress is generated in the positive and negative x-directions from the outside to the inside in association with the contraction; in the sides L3 and L4 extending in the y-direction, a stress is generated in the positive and negative y-directions from the outside to the inside in association with the contraction. Thus, the region A1 around the corner C1 serves as a starting point of positive x- and y-direction stresses, the region A2 around the corner C2 serves as a starting point of negative x-direction and positive y-direction stresses, the region A3 around the corner C3 serves as a starting point of positive x-direction and negative y-direction stresses, and the region A4 around the corner C4 serves as a starting point of negative x- and y-direction stresses. As a result, as illustrated in FIG. 3, a crack F may occur around the corners C1 to C4 to degrade reliability of the battery.

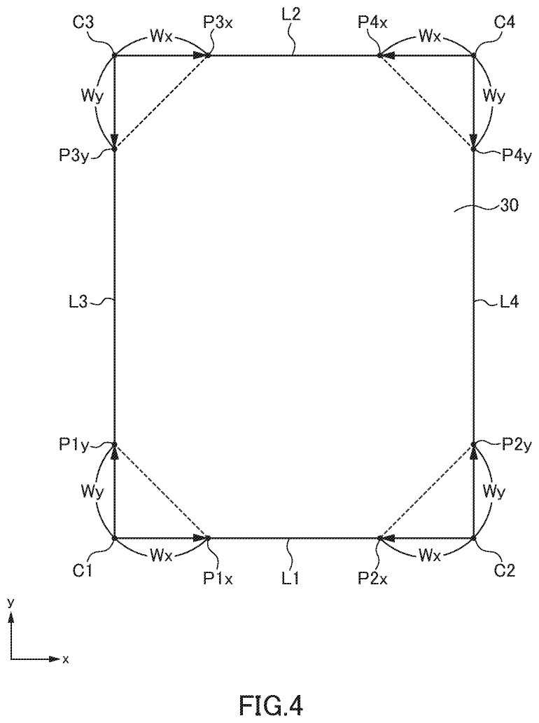

As described above, in the region around the corner serving as a starting point of the stresses in two directions, deformation such as the crack F is likely to occur. Specifically, as illustrated in FIG. 4, when a point P1x away from the corner C1 by a distance Wx in the positive x-direction and a point P1y away from the corner C1 by a distance Wy in the positive y-direction are defined, a triangular region having the corner C1, point P1x, and point P1y as vertices can serve as a starting point of stresses in two directions. The same can be said for the other corners C2 to C4. That is, when a point P2x away from the corner C2 by a distance Wx in the negative x-direction and a point P2y away from the corner C2 by a distance Wy in the positive y-direction are defined, a triangular region having the corner C2, point P2x, and point P2y as vertices can serve as a starting point of stresses in two directions. When a point P3x away from the corner C3 by a distance Wx in the positive x-direction and a point P3y away from the corner C3 by a distance Wy in the negative y-direction are defined, a triangular region having the corner C3, point P3x, and point P3y as vertices can serve as a starting point of stresses in two directions. When a point P4x away from the corner C4 by a distance Wx in the negative x-direction and a point P4y away from the corner C4 by a distance Wy in the negative y-direction are defined, a triangular region having the corner C4, point P4x, and point P4y as vertices can serve as a starting point of stresses in two directions.

Considering the above, in the present embodiment, the negative electrode 30 is cut such that the negative electrode current collector 32 and negative electrode active material layer 34 are absent in the triangle region. With this configuration, a portion serving as a starting point of the stress in two directions is positioned outside the negative electrode 30, making deformation such as the crack F illustrated in FIG. 3 less likely to occur.

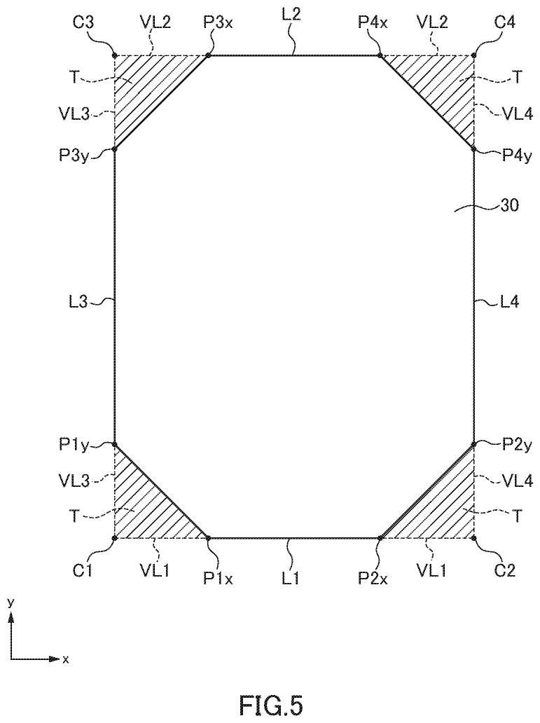

FIG. 5 is a plan view illustrating a first example of the negative electrode 30. In the first example, only the above-mentioned triangular regions T are cut away, with the result that the negative electrode 80 is formed in an octagonal shape. This minimizes the area of the cut-away part, making it possible to minimize a reduction in capacity. In this case, the corner C1 is defined as an intersection between a straight line VL1 along the side L1 and a straight line VL3 along the side L3, the corner C2 is defined as an intersection between the straight line VL1 along the side L1 and a straight line VL4 along the side L4, the corner C3 is defined as an intersection between a straight line VL2 along the side L2 and the straight line VL3 along the side L3, and the corner C4 is defined as an intersection between the straight line VL2 along the side L2 and a straight line VL4 along the side L4.

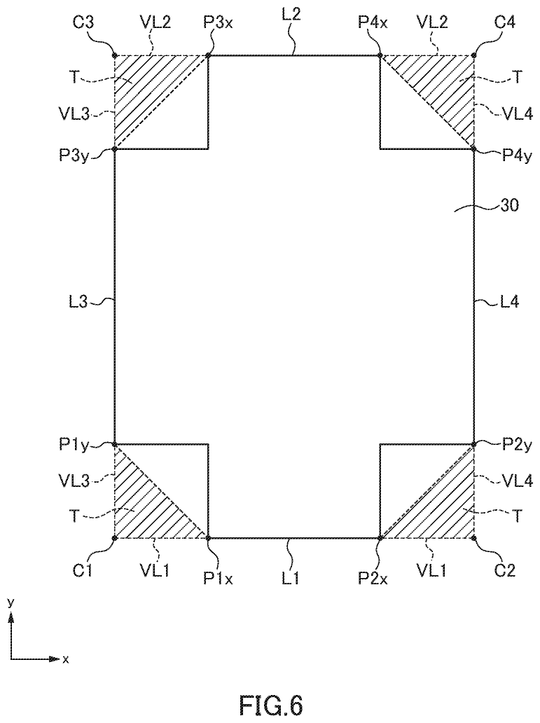

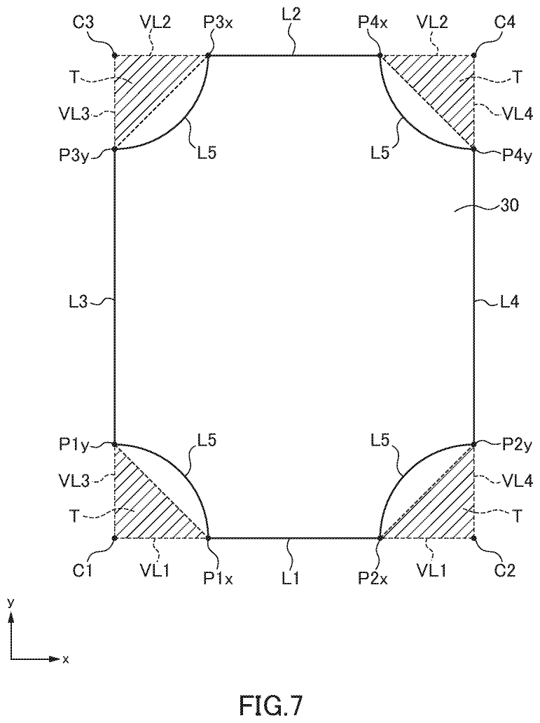

FIG. 6 is a plan view illustrating a second example of the negative electrode 30. In the second example, quadrangle regions each including the above-mentioned triangular region are cut away, with the result that the negative electrode 80 is formed in a cross shape. FIG. 7 is a plan view illustrating a third example of the negative electrode 30. In the third example, fan-shaped regions each including the above-mentioned triangular region are cut away, and sides L5 resulting from the cutting away are each formed in a concave circular-arc shape. As described above, when a wider region including the triangular region is cut away, deformation such as cracking becomes less likely to occur.

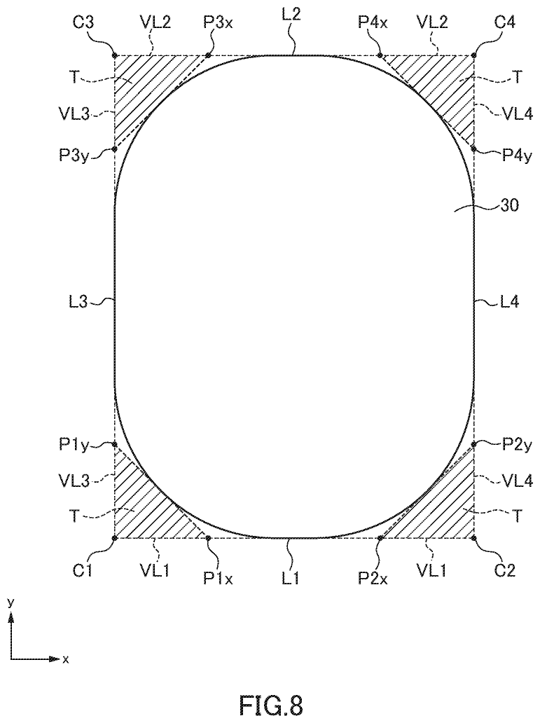

FIG. 8 is a plan view illustrating a fourth example of the negative electrode 30. In the fourth example, the sides L5 that are the result of cutting away are each formed in a convex circular-arc shape. In this case, the vertices defining the triangular region are positioned outside the negative electrode 30. Thus, the negative electrode may be cut away such that the vertices defining the triangular region are positioned outside the negative electrode 30.

As described above, since the triangular regions positioned at the corners of the negative electrode 30 are cut away, the non-aqueous electrolyte secondary battery according to the present embodiment can suppress deformation such as cracking associated with charging/discharging even in a configuration in which deformation is very likely to occur with the area change rate and thickness change rate of the negative electrode active material layer 34 associated with charging being 0.1% or more and 10% or more, respectively.

It is apparent that the present invention is not limited to the above embodiments, but may be modified and changed without departing from the scope and spirit of the invention.

What is claimed is:

1. A negative electrode for non-aqueous electrolyte secondary battery comprising:
a negative electrode current collector; and
a negative electrode active material layer including a negative electrode active material disposed on a surface of the negative electrode current collector,
wherein an area change rate and a thickness change rate of the negative electrode active material layer associated with charging are 0.1% or more and 10% or more, respectively,
wherein each of the negative electrode current collector and the negative electrode active material layer has a first side extending in a first direction and a second side extending in a second direction perpendicular to the first direction,
wherein a triangular region having an intersection, a first point, and a second point as vertices are cut away such that the triangular region has neither the negative electrode current collector nor the negative electrode active material layer, where the intersection is defined between a first straight line along the first side and a second straight line along the second side, where the first point exists on the first straight line and being away from the intersection in the first direction toward the first side by a first distance, and where a second point exists on the second straight line and being away from the intersection in the second direction toward the second side by a second distance.

2. A non-aqueous electrolyte secondary battery comprising:
a negative electrode having a negative electrode current collector and a negative electrode active material layer including a negative electrode active material disposed on a surface of the negative electrode current collector;
a positive electrode having a positive electrode current collector and a positive electrode active material layer including a positive electrode active material disposed on a surface of the positive electrode current collector; and
a separator disposed between the positive and negative electrodes,
wherein an area change rate and a thickness change rate of the negative electrode active material layer associated with charging are 0.1% or more and 10% or more, respectively,
wherein each of the negative electrode current collector and the negative electrode active material layer has a first side extending in a first direction and a second side extending in a second direction perpendicular to the first direction,
wherein a triangular region having an intersection, a first point, and a second point as vertices are cut away such that the triangular region has neither the negative electrode current collector nor the negative electrode active material layer, where the intersection is defined between a first straight line along the first side and a second straight line along the second side, where the first point exists on the first straight line and being away from the intersection in the first direction toward the first side by a first distance, and where a second point exists on the second straight line and being away from the intersection in the second direction toward the second side by a second distance.

3. The non-aqueous electrolyte secondary battery as claimed in claim 2, wherein the positive electrode active material contains lithium nickel composite oxide represented by a general formula: LiₐNi_{b}Mn_{c}Co_{d}MₓO₂ (where a, b, c, d, and x satisfy 0.9≤a≤1.2, 0<b<1, 0<c≤0.5, 0<d≤0.5, 0≤x≤0.3, b+c+d=1, and M is at least one element selected from a group consisting of Ti, Zr, Nb, W, P, Al, Mg, V, Ca, Sr, and Cr).

4. The non-aqueous electrolyte secondary battery as claimed in claim 2, wherein the separator has a structure obtained by laminating a heat-resistant insulating layer on a porous body.

5. The non-aqueous electrolyte secondary battery as claimed in claim 2, wherein the negative electrode has a capacity per unit area of 1.2 mAh/cm² or more.

6. The non-aqueous electrolyte secondary battery as claimed in claim 2, wherein the non-aqueous electrolyte secondary battery is a stacked type battery in which the positive electrode, negative electrode, and separator are encapsulated in an outer casing.
